(19) United States
(12) Patent Application Publication
(10) Pub. No.: US 2012/0151010 A1
(43) Pub. Date: Jun. 14, 2012

(54) ELECTRONIC DEVICE AND METHOD FOR PLAYING MEDIA CONTENT

(75) Inventor: TENG-YU TSAI, Tu-Cheng (TW)

(73) Assignee: HON HAI PRECISION INDUSTRY CO., LTD., Tu-Cheng (TW)

(21) Appl. No.: 13/205,692

(22) Filed: Aug. 9, 2011

(30) Foreign Application Priority Data
Dec. 13, 2010 (TW) 99143432

(51) Int. Cl. G06F 15/16

(52) U.S. Cl. 709/219

(57) ABSTRACT

Disclosed is an electronic device playing digital media content. The electronic device examines a uniform resource locator (URL) by comparing the string of the URL to predetermined patterns. If the URL matches one pattern, the electronic device provides the URL to a media play, otherwise the electronic device download a file associated with the URL. The electronic device extracts another URL from the file and examines the extracted URL as well. If the extracted URL passes the examination by the electronic device, it can be provided to the media player. When the media player receives a URL, it plays the media content associated with the received URL.

### BACKGROUND

1. Technical Field

The disclosure generally relates to an electronic device and a method for playing digital media content from a network.

2. Description of Related Art

In computer programming, a media player refers to a software application for playing digital media such as audio and/or video. Many media players are capable of playing media files from both a local storage device and a remote media server such as a music website on the Internet. Typically, such media players need a uniform resource locator (URL) to locate a media file or a media steam from a remote media server. However, these media players could hardly determine whether a URL locates media resource truly or not before these media players try to play media content associated with that URL. Therefore, there is room for improvement in the media players.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a schematic diagram of one embodiment of an electronic device suitable for use in implementing a media playing system.

FIG. 2 is a table presenting some patterns for examining URLs of variety media types according to one embodiment.

FIG. 3 is an operational flow diagram representing an exemplary embodiment of a method for checking a pattern file.

FIG. 4 is an operational flow diagram representing an exemplary embodiment of a method for playing media content from a network.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language, such as, Java, C, or assembly. One or more software instructions in the modules may be embedded in firmware, such as EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

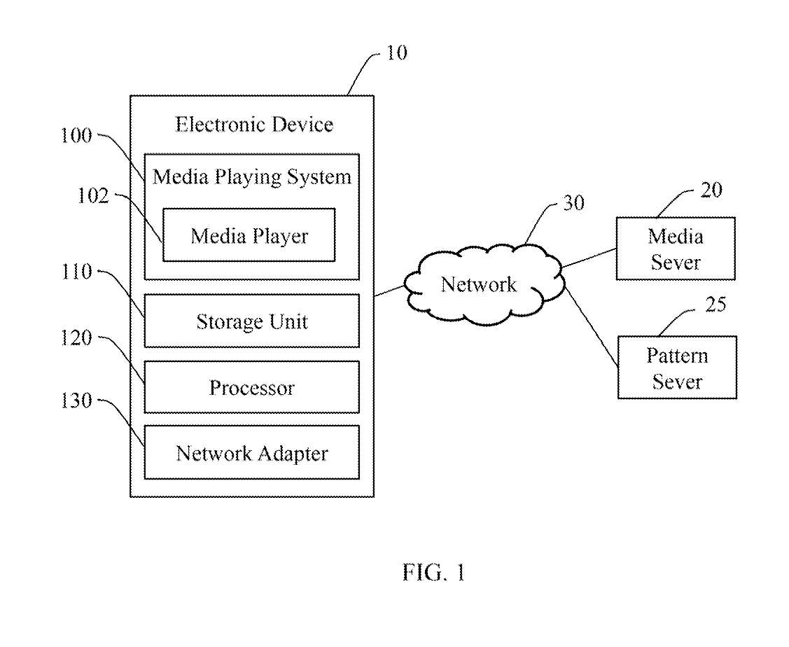

FIG. 1 is a schematic diagram of one embodiment of an electronic device 10. In the embodiment, the electronic device 10 may include a media playing system 100, a storage unit 110, at least one processor 120, and a network adapter 130. The electronic device 10 implements the functions of the media playing system 100. The electronic device 10 is a general purpose computing device such as a desktop computer, a laptop computer, a tablet PC or a smart phone. The storage unit 110 may be a magnetic or an optical storage device, such as a hard disk drive, an optical drive, or a tape drive.

With reference with FIG. 1, the electronic device 10 may operate in a network 30 which provides logical connections to one or more remote computers, such as a media server 20 and a pattern server 25. The network 30 may be a local area network (LAN) or a wide area network (WAN), such as the Internet. The electronic device 10 is connected to the network 30 through the network adapter 130. The network adapter 130 may be a network interface card using a specific physical layer and a data link layer standard such as Ethernet or Wi-Fi.

The media server 20 may provide media files or streams of variety media types, such as ASF, MP4 and FLV, in numerous network protocols, such as HTTP, FTP and MMS.

In computing, a uniform resource locator (URL), also referred to a uniform resource identifier (URI), is defined to specify where a known resource is available. For example, a URL “http://gl.op.cc/reco.mp3” may specify an audio file named “reco.mp3” located in a remote server whose domain name is “gl.op.cc” in the HTTP protocol.

The media playing system 100 may include a media player 102. The media player 102 is capable of playing media files from both the storage unit 110 and the media server 20. The media player 102 may be instructed by the media playing system 100 to play a particular media file or a media stream which is indicated by a URL. The media content that the media player 102 can play includes audio and/or visual content.

A URL may indicate a resource of any type, which may be a media file and may not be. In order to determine whether a URL is specifying a media file or a media stream, a plurality of patterns is set to check whether the string of the URL meets the criterion of a known media type. In one embodiment, the plurality of patterns comprises a plurality of regular expressions. The regular expression (also referred to as regex or regexp) is a powerful industry-standard technology used to examine text and identify parts that match a provided specification. A regular expression is written in a formal language that has a detailed syntax defined by a particular regex standard such as IEEE POSIX Basic Regular Expressions (BRE) standard, Extended Regular Expressions (ERE) standard or Simple Regular Expressions (SRE) standard. For example, if one needs to find either the word “color” or “colour”, he can use the regular expression: “colou?r”. The “?” symbol means to include 0 or 1 instances of the previous character in the match pattern. In this case both “color” and “colour” match this regular expression.

While a URL may not specify a media resource directly, it may indicate an intermediate file that contains another URL which could specify a media resource. In that case, the media playing system 100 may download the intermediate file associated with a URL, extract another URL from that file and examine the extracted URL by comparing the string of the extracted URL to the patterns.

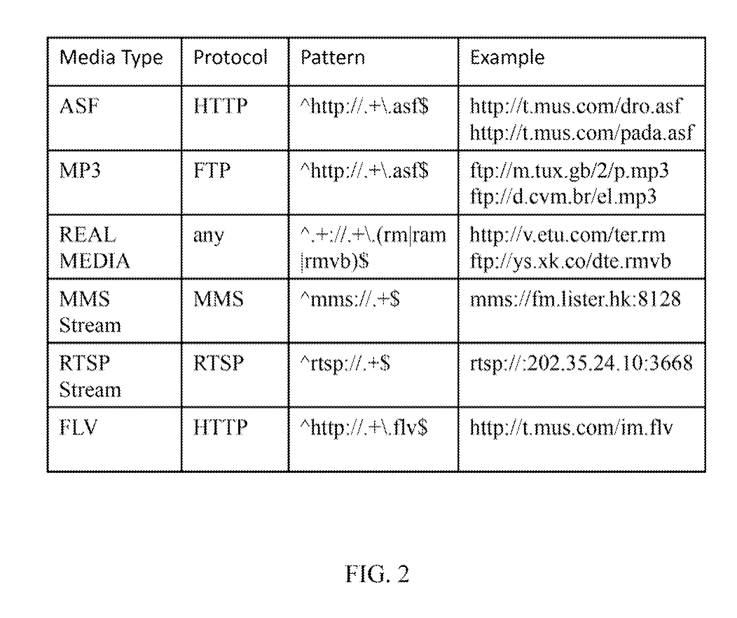

FIG. 2 illustrates a table of some patterns for examining URLs of variety media types. In the table, all patterns are written in regular expressions. If the string of a URL matches any one pattern depicted in the table, the URL can be determined to be a valid URL that specifies a media file or a stream. If the string of a URL matches none of the patterns, it can be determined to be an invalid URL that indicates a media file or a stream directly. For example, both “http://t.mus.com/dro.asf” and “http://t.mus.com/pada.asf” match a pattern “̂http://.+\.asf$” and thereby the two URLs are valid to specify media files of an ASF type in the HTTP protocol. For another example, “http://10.35.20.1/ts.htm” is an invalid URL because it cannot match any pattern in the table.

In one embodiment, the patterns may be stored in a pattern file in the storage unit 110. The patterns may be stored in the pattern file in the extended markup language (XML) format since the patterns are written as plain text. The pattern server 25 may provide an updated pattern file, which is maintained by a developer. When a new media type or a new protocol arises to be available, the developer can add a new corresponding pattern to the pattern file in the pattern server 25. The media playing system 100 may connect to the pattern server 25 and download the pattern file in response to a user selection in a user interface (UI) or a predetermined event. A predetermined event, for example, can be detection that the pattern file is not found in the storage unit 110. Another predetermined event can be a timer that triggers every a period of time such as a few hours.

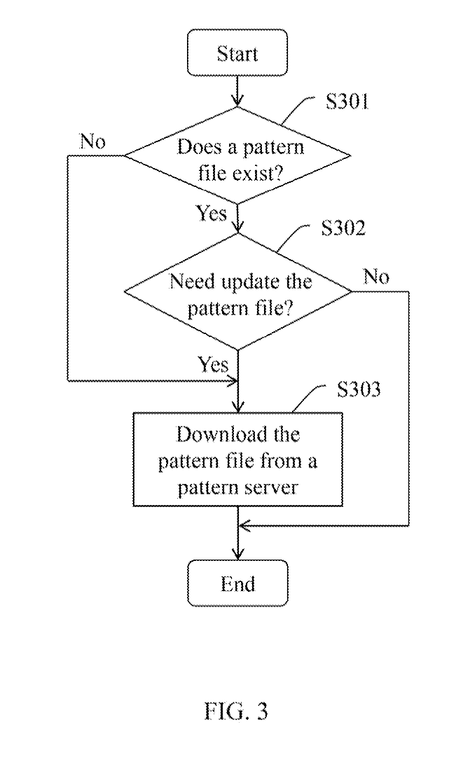

FIG. 3 is a flowchart illustrating one embodiment of a method for checking a pattern file. The method may include the following steps.

In step S301, the media playing system 100 determines whether there is a pattern file which includes a plurality of patterns in the storage unit 110. If the pattern file exists in the storage unit 110, then the flow goes to step S302, otherwise the flow goes to step S303.

In step S302, the media playing system 100 determines whether the pattern file stored in the storage unit 110 needs to be updated. If the user selection of the user interface requires an update or the predetermined event is found, the flow goes to step S303, otherwise the flow ends.

In step S303, the electronic device 10 connects to the pattern server 25, downloads the pattern file from the pattern server 25, and stores the downloaded pattern file in the storage unit 110. If there a pattern file already exists in the storage unit 110, the downloaded pattern file replaces that pattern file in the storage unit 110.

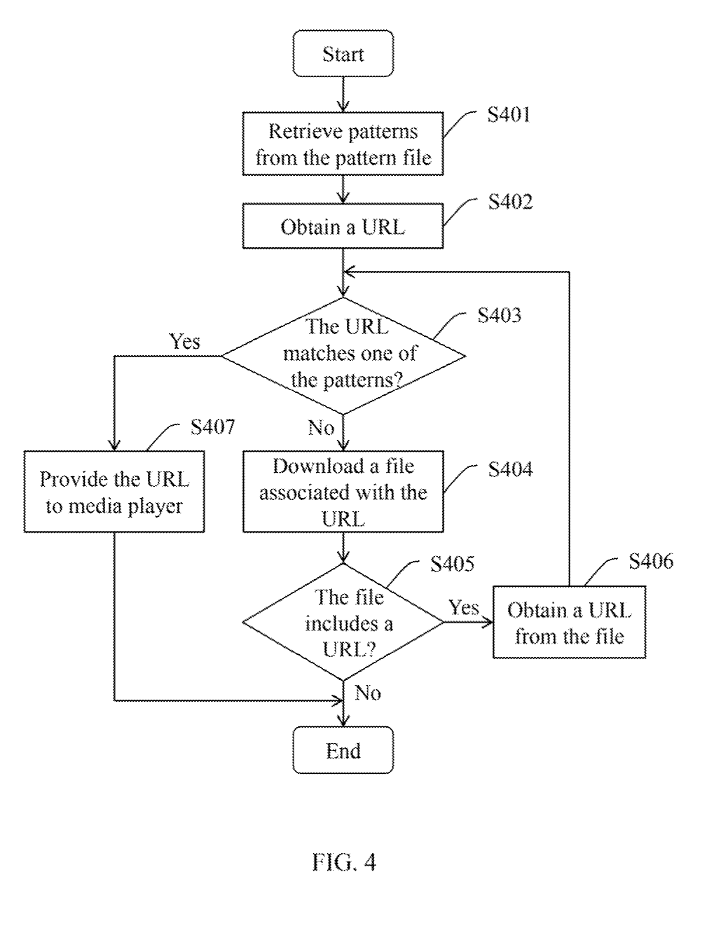

FIG. 4 is a flowchart illustrating one embodiment of a method for playing media content from a network. The method may include the following steps.

In step S401, the media playing system 100 retrieves patterns from the pattern file stored in the storage unit 110.

In step S402, the media playing system 100 obtains a URL which is going to be provided to the media player 102.

In step S403, the media playing system 100 determines whether the string of the URL matches one of the patterns by comparing the string of the URL to the patterns. If the string of the URL matches one of the patterns, the flow goes to step S407. If the string of the URL matches none of the patterns, the flow goes to step S404.

In step S404, the media playing system 100 downloads a file associated with the URL. The file may be an HTML file, an XML file or other than media file.

In step S405, the media playing system 100 determines whether the file contains another URL. If there is a URL described in the file, the flow goes to step S406, otherwise the flow ends.

In step S406, the media playing system 100 extracts a URL from the file. Then the flow goes to the step S403.

In step S407, the media playing system 100 provides the URL to the media player 102 and instructs the media player 102 to play the media content associated with the URL.

It is to be understood, however, that even though numerous characteristics and advantages have been set forth in the foregoing description of embodiments, together with details of the structures and functions of the embodiments, the disclosure is illustrative only and changes may be made in detail, especially in matters of shape, size, and arrangement of parts within the principles of the disclosure to the full extent indicated by the broad general meaning of the terms in which the appended claims are expressed.

Depending on the embodiment, certain steps or methods described may be removed, others may be added, and the sequence of steps may be altered. It is also to be understood that the description and the claims drawn for or in relation to a method may include some indication in reference to certain steps. However, any indication used is only to be viewed for identification purposes and not as a suggestion as to an order for the steps.

What is claimed is:

1. A computer-implemented method for playing media content from a network in an electronic device having a processor and a storage unit, the method comprising:
determining, by the processor, whether a string of a first uniform resource locator (URL) matches one of a plurality of patterns, wherein the plurality of patterns is stored in the storage unit;
when the string of the first URL matches one of the plurality of patterns, providing the first URL to a media player and instructing the media player to play media content associated with the first URL;
when the string of the first URL matches none of the plurality of patterns, downloading a file associated with the first URL and obtaining a second URL described in the file; and
providing the second URL to the media player and instructing the media player to play media content associated with the second URL according to a determination that a string of the second URL matches one of the plurality of patterns.

2. The method of claim 1, wherein the plurality of patterns comprises a plurality of regular expressions.

3. The method of claim 1, wherein the plurality of patterns is stored in a pattern file in the storage unit.

4. The method of claim 3, wherein the plurality of patterns is stored in the pattern file in an XML format.

5. The method of claim 1, wherein the electronic device is in electronic communication with a pattern server on the network, the method further comprising:
when a predetermined event is detected, downloading a pattern file from the pattern server, the pattern file comprising the plurality of patterns; and
storing the pattern file in the storage unit.

6. The method of claim 5, wherein the predetermined event is a timer that triggers every a period of time.

7. The method of claim 5, wherein the predetermined event is a user selection in a user interface.

8. The method of claim 5, wherein the predetermined event is detection that the pattern file does not exist in the storage unit.

9. The method of claim 1, wherein the media content comprises audio and/or visual content.

10. The method of claim 1, wherein the media content is in a file format.

11. The method of claim 1, wherein the media content is in a stream.

12. An electronic device, comprising:
a storage unit that stores a plurality of patterns;
a processor that
provides a first uniform resource locator (URL) to a media player and instructs the media player to play media content associated with the first URL according to a determination that a string of the first URL matches one of the plurality of patterns, and
downloads a file associated with the first URL, obtains a second URL described in the file, provides the second URL to the media player and instructs the media player to play media content associated with the second URL upon the condition that a string of the second URL is determined to match one of the plurality of patterns according to a determination that a string of the first URL matches none of the plurality of patterns.

13. The electronic device of claim 12, wherein the plurality of patterns comprises a plurality of regular expressions.

14. The electronic device of claim 12, wherein the plurality of patterns is stored in a pattern file in the storage unit.

15. The electronic device of claim 14, wherein the plurality of patterns is stored in the pattern file in an XML format.

16. The electronic device of claim 12, wherein the electronic device is in electronic communication with a pattern server on the network, the processor is further adapted to download a pattern file from the pattern server and store the pattern file in the storage unit, the pattern file comprising the plurality of patterns.

17. The electronic device of claim 12, wherein the media content comprises audio and/or visual content.

18. The electronic device of claim 12, wherein the media content is in a file format.

19. The electronic device of claim 12, wherein the media content is in a stream.
